(19) United States
(12) Patent Application Publication
(10) Pub. No.: US 2001/0047303 A1
(43) Pub. Date: Nov. 29, 2001

(54) System for supplying truck tires

(76) Inventor: Paul M. Greenstone, Farmington Hills, MI (US)

Correspondence Address: Mark D. Schneider, Gifford, Krass, Groh, Sprinkle,, Anderson & Citkowski, P.C., 280 North Old Woodward, Suite 400, Birmingham, MI, 48009, US

(21) Appl. No.: 09/773,239

(22) Filed: Jan. 31, 2001

Related U.S. Application Data
(60) Provisional application No. 60/179,270, filed on Jan. 31, 2000.

(51) Int. Cl. G06G 1/14; G06F 17/60

(52) U.S. Cl. 705/22

(57) ABSTRACT

A method for identifying a supply source (e.g., a seller) for truck tire products that is nearest to a customer's location or desired point of delivery and for obtaining delivery from that source. Preferably, the method includes: a first step of providing an electronic interface; a second step of receiving a customer inquiry through the interface; a third step of storing in a computer database tire source information; a fourth step of executing a search of the computer database to identify a source of a tire product requested by a customer's inquiry; a fifth step of receiving a purchase order and payment from a customer through the electronic interface, and; a sixth step of transmitting the purchase order to a tire source or source(s).

### CROSS-REFERENCE TO RELATED APPLICATIONS

This patent claims the benefit of priority from U.S. Provisional Patent Application Ser. No. 60/179,270 filed Jan. 31, 2000.

### BACKGROUND OF THE INVENTION

1. Field of the Invention

The present invention is directed to a method for locating and distributing goods. More specifically, the invention is directed to a location and distribution system for the ordering and delivery of commercial truck tires or other similar types of goods.

2. Reference to Related Art

Truck tires, particularly commercial truck tires, are known for having considerable size and weight. However, tires are also by their very nature a consumable product. Therefore, after a period of use, even the most efficient business must replace the tires on its trucks or other vehicles.

When ordering a new or replacement tire(s), the tire's characteristics of size and weight combine to present commercial disadvantages to tire sellers and buyers alike. For example, because of a tire's size and weight, tires must often be sold only on a regional basis. Regional sales, instead of national, lowers the seller's overhead shipping costs, but may also limit the availability and variety of products a seller might offer to a buyer. Furthermore, due to the consumable nature of the tire, a buyer may need to replace it at a moment's notice, without warning or consideration for the buyer's location. Therefore, at a time when a buyer must obtain a replacement tire(s), the buyer must also confront several other problems including: (1) where can the buyer find a source (a seller) for replacement tires; (2) will that tire source have the tire product required by the buyer available in its inventory, and; (3) is the tire source the closest source to the buyer so that the buyer can minimize its own shipping costs for the replacement tire(s)?

The system of the present invention allows a buyer to locate quickly and easily the nearest source or seller of tires, confirm that the required product is available in the seller's inventory and obtain delivery tire(s). While other distribution methods are shown in the art, those methods do not disclose the advantages of the present invention. For example, International Publication No. WO 90/11572 discloses an integrated electronic parts warehousing and distribution system and method. Specifically, the international publication discusses an integrated parts order system wherein the parts are located in a single central warehouse system. Therefore, this international reference does not address the disadvantages outlined above concerning finding the closest available source for obtaining tire products or similar types of goods.

Additionally, U.S. Pat. Nos. 6,023,683 and 6,055,516 issued to Johnson et al. disclose electronic sourcing systems that permit a user to search a database and generate a requisition for a product. The system then checks for the availability of the product in one or more inventory locations and then generates one or more purchase orders for the product from the location stocking the item. However, the Johnson system is clearly not designed to locate the closest source for available inventory or otherwise address the above outlined needs of the buyer.

### BRIEF SUMMARY OF THE INVENTION

The present invention is directed to a system that permits the trucking industry (i.e., manufacturers, independent trucking contractors, truck fleets and domestic or international trucking concerns) to identify the nearest source for replacement or retread tire product(s), confirm that the required tire product(s) is in inventory, and process a purchase order to obtain delivery of the tire product(s). In this system, the ability to identify the nearest source for tires decreases the customer's shipping cost and delivery time.

More specifically, the present invention discloses a method for identifying the closest source or sources of commercial truck tires and supplying the tires to a customer. The method includes a first step of providing an electronic interface at a central processing station for receiving an inquiry from a customer regarding the availability of a commercial truck tire product. The customer then transmits a product inquiry through the electronic interface that it is received by the central processing station.

Preferably, the central processing station maintains or has access to a computer database that stores location and inventory information from at least one tire source or seller. Upon receiving the customer inquiry, a comparison search is undertaken in the database to identify the tire source closest to the customer's geographic location or required point of delivery. If the inventory of the tire source closest to the customer's location includes the product or products requested by the customer, the customer transmits through the electronic interface a purchase order and payment that is received at the central processing station. However, if the inventory of the tire source closest to the customer's geographic location does not include a product requested by the customer, an additional search of the database is initiated to identify the tire source that is next closest in distance to the customer's location. Thereafter, a search is executed of the inventory of the next closest tire source to locate the customer's product(s). Preferably, the search of tire sources and inventory will continue until each tire source closest to the customer's location that also has the customer's requested product in inventory is identified. After the tire source(s) having the product in inventory is identified, the customer may issue a purchase order as discussed above.

Preferably, the purchase order with payment (i.e., a credit card number, electronic fund transfer, etc.) is transmitted from the central processing station to the identified tire source(s) for same day execution of the order. A percentage (preferably from 1-25%) of the payment transmitted by the customer to the central processing station is retained by the central location as a commission and the remainder of the purchase funds are forwarded to an account for the identified tire source(s). Alternatively, the tire source and the central processing station may agree on a profit sharing plan (e.g. 1-50% of gross profits for each sale) where payment is made upon receipt of the customer's order or upon delivery.

### BRIEF DESCRIPTION OF THE SEVERAL VIEWS OF THE DRAWINGS

The features, aspects and advantages of the present invention will become better understood with regard to the following description, claims and accompanying drawings wherein:

FIG. 1 is a flow-chart view of a preferred embodiment of the method of the present invention.

FIG. 2 is a diagrammatic view of a preferred embodiment of the method of the present invention.

### DETAILED DESCRIPTION OF A PREFERRED EMBODIMENT OF THE INVENTION

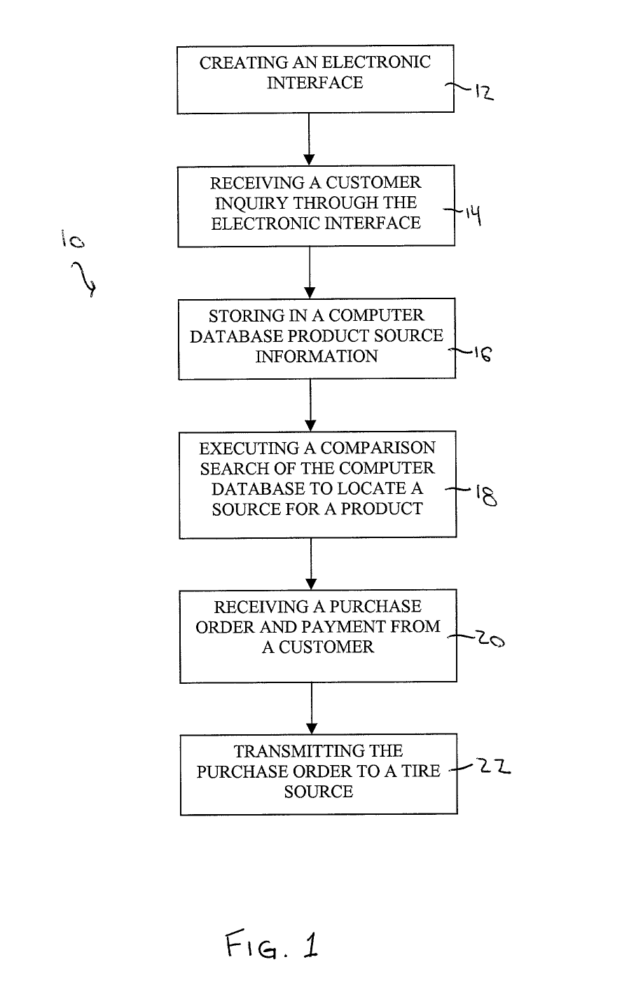

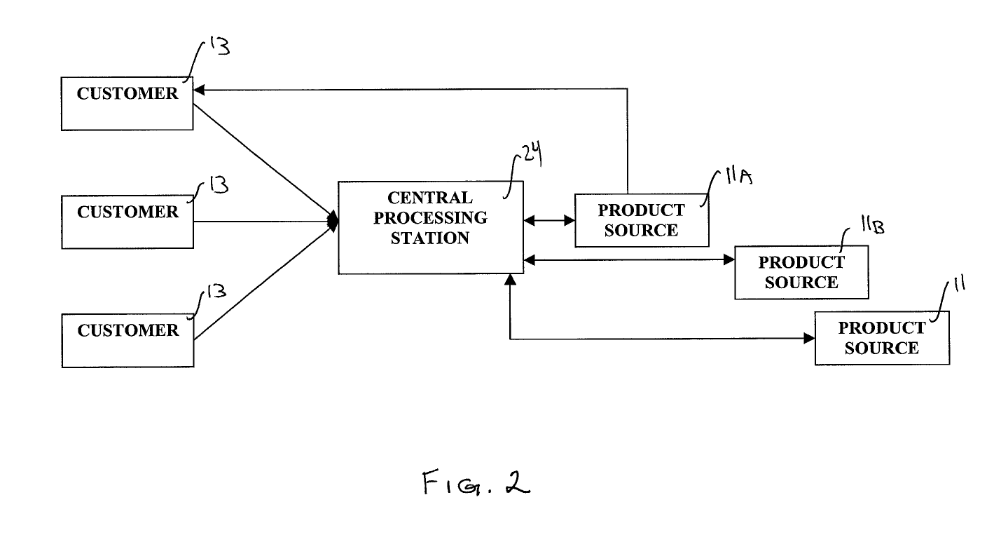

Referring now to FIGS. 1 and 2, there is shown a preferred embodiment of a method 10 for identifying and obtaining delivery from a supply source 11 (e.g., seller) for commercial truck tires that is the geographically closest source(s) to a customer 13. Preferably, the method 10 includes: a first step 12 of providing an electronic interface; a second step 14 of receiving a customer inquiry through the interface; a third step 16 of storing in a computer database tire source information; a fourth step 18 of executing a search of the computer database to identify a source of a tire product requested by a customer's inquiry; a fifth step 20 of receiving a purchase order and payment from a customer 13 through the electronic interface, and; a sixth step 22 of transmitting the purchase order to a tire source or source(s).

Still referring to FIGS. 1 and 2, in a first step 12 of a preferred embodiment of the invention, an electronic interface is created at a central processing station 24. A skilled artisan will recognize that various electronic devices such as fax machines, personal computers (PCs); website servers, databases, handheld devices, printers, WAP-phones, WEB TV, wireless and wired devices, and storage media may be used to create the interface and to locate, create, store, transfer, or otherwise connect and facilitate the processing of a customer's inquiry (discussed below). For example, at least one customer 13 may use software to transmit a customer inquiry in electronic form via the Internet to a PC utilized by the central processing station 24. Alternatively, a secure intranet system may be established between the central processing station 24 and the customer 13 to facilitate communication through the electronic interface.

In the second step 14, a customer 13 in need of a tire product, such as a new or retread tire(s), transmits through the electronic interface a customer product inquiry in an electronic form that is received at the central processing station 24. Preferably, the customer's product inquiry includes, but is not limited to, data indicating the customer's present geographic location (or alternatively the location where the customer 13 desires the product to be delivered) and product request data (e.g., serial number, make, size, model number, etc.) of the tire product or products required by the customer.

Still referring to FIGS. 1 and 2, in a third step 16 there is a computer database maintained or electronically accessible from the central processing station 24. Preferably, the database is Internet compatible and stores tire source information for at least one tire source 11. A tire source 11 is preferably a tire retailer. However, it should be anticipated that tire resellers, wholesalers, manufacturers, brokers, or any entity engaged in the business of selling tires may function as a tire source 11.

Preferably, the tire source information stored in the database includes information identifying the geographic location of the tire source 11 and information describing the tire source's 11 available inventory. For example, the tire source inventory information may include, but is not limited to, information concerning available products, and each product's size, weight, price, model number. The database is preferably updated on a daily basis. However, most any predetermined period (daily, weekly, monthly), according to the requirements of the user, may be used to update the database.

In a fourth step 18, upon receiving a customer inquiry through the electronic interface, the central processing station executes a comparison search in the database of: 1) the customer's 13 location with the location information for each tire source 11 to identify the tire source 11 a closest to the customer's 13 location and; 2) the customer's 13 product request data with the closest tire source's 11 inventory information. More particularly, upon identification of the tire source 11a that is closest to the customer's geographic location as indicated by the customer inquiry, a search is undertaken of that tire source's inventory information. If the inventory information for the closest tire source 11a includes a product required by the customer 13 in the customer inquiry, the customer 13 is provided the name of that closest tire source 11 a, the source's inventory information for that product and shipping information.

If a product identified in the customer inquiry is not available from the first identified closest tire source 11a, an additional search of the database is undertaken to identify the tire source 11b that is the next closest to the customer's location. Thereafter, a review of the next identified tire source's 11b inventory data is undertaken for a product required by the customer 13 in the customer inquiry. Preferably, the process of searching for tire sources 11 and review of the source's inventory will continue until the tire source closest to the customer's location having the product required by the customer 13 in the customer inquiry is identified. Therefore, it should be appreciated that the products required by a customer may be located at several different sources 11, with no one source having all the products required by the customer. Alternatively, a single source 11 may be identified that is not necessarily the closest source but which has all the products required by the customer. Where a nearest single source 11 having all the products required by the customer is identified, the customer may be given the option to purchase from that single source even though it is not the closest source for a particular product.

Still referring to FIGS. 1 and 2, in a fifth step 20, upon identification of the tire source 11a having the customer product in inventory, the customer transmits a purchase order and payment in electronic form through the electronic interface to the central processing station 11. Preferably, payment is by credit card. However, electronic fund transfer or other forms of electronic payment may also be used with the present method.

In a sixth step 22, the purchase order is transmitted from the central processing station 24 to the tire source(s) 11 identified in the comparison search for execution of the purchase order. Preferably, the central location will retain a percentage (between 1 to 25%) of the customer's 13 payment as a commission. Alternatively, the tire source and the central processing station may agree on a profit sharing plan (e.g. 1-50% of gross profits for each sale) where payment is made upon receipt of the customer's order or upon delivery.

The present method does not inherently limit the number or types of products that may be ordered by the customer or the location where those products may be delivered (either foreign or domestic). However, in a preferred embodiment, bulk orders for commercial truck tires will not exceed 280 units.

It should also be appreciated that application of the method of the present invention is not limited to commercial truck tires. Rather, the method of the present invention might also be used in connection with the distribution of a variety of large and otherwise heavy products, including, but not limited to, engine blocks, industrial manufacturing supplies and raw or aggregate materials.

Having thus described the method of the present invention, it will be apparent to those of skill in the art that various modifications and improvements may be made to the method without departing from the scope of the invention.

I claim:

1. A method for locating the nearest source of a product to a customer, the method comprising the steps of:
providing an electronic interface;
receiving through said electronic interface a customer inquiry concerning a product, said customer inquiry comprising customer location data and product request data;
storing in a computer database source information, said source information comprising source location information and source inventory information;
executing a comparison search in said computer database of said customer inquiry with said source information to identify a first source having a location closest to a customer location and having said source inventory information that includes said product request data;
receiving through said electronic interface a purchase order for said product;
transmitting said purchase order to said first source having a location closest to said customer location.

2. The method of claim 1, further comprising the step of executing a second comparison search in said computer database of said customer inquiry with said source information to identify a second source having a next closest location said customer location and having said source inventory information that includes said product request data;

3. The method of claim 1, further comprising the step of receiving through said electronic interface a payment for said product;

4. The method of claim 3, wherein further comprising the step of retaining a percentage of said payment as a commission;

5. The method of claim 4, wherein said percentage of said payment retained as a commission is between 1-25% of said payment;

6. The method of claim 4, wherein said percentage of said payment retained as a commission is between 1-50% of a profit for said product for said first source.

7. The method of claim 1, wherein said customer inquiry is received in electronic form;

8. The method of claim 1, furthering comp rising the step of shipping said product from said first source to said customer.

9. The method of claim 2, further comprising the step of shipping said product from said second source to said customer.

10. A method for locating the distribution of a product from a source nearest source closest to a customer's location, the method comprising the steps of:
providing an electronic interface;
receiving through said electronic interface a customer inquiry from a customer concerning a product, said customer inquiry comprising customer location data;
storing in a computer database source information for a supply source, said source information comprising source location information;
executing a comparison search in said computer database of said customer inquiry with said source information to identify a supply source having a location closest to a customer location;
receiving through said electronic interface a purchase order from said customer for said product;
transmitting said purchase order to said supply source having a location closest to said customer location.

11. The method of claim 10, furthering comprising the step of shipping said product from said supply source to said customer.

12. A method for locating the closest source of commercial truck tires and supplying said tires to a customer, the method comprising the steps of:
creating an electronic interface for receiving a customer inquiry regarding the availability of a commercial truck tire product;
receiving through said electronic interface a customer inquiry regarding the availability of a commercial truck tire product, said customer inquiry comprising customer location information and a product identification;
storing in a computer database tire information, said tire information comprising tire source location information and tire inventory information;
executing a comparison search in said computer database of said customer inquiry and said tire information to identify a tire source location closest to said customer location and verifying that said tire inventory information at said tire source location includes the customer's product identification;
receiving through said electronic interface a purchase order and payment for said commercial truck tire product from said customer;
transmitting said purchase order to a tire source location.
